(19) United States
(12) Patent Application Publication
(10) Pub. No.: US 2018/0098547 A1
(43) Pub. Date: Apr. 12, 2018

(54) Fine Particulate Dispenser with Quick Access Panel

(71) Applicant: Burford Corporation, Maysville, OK (US)

(72) Inventors: Jimmy Frazier, Norman, OK (US); Robert Mackey, Mannford, OK (US)

(73) Assignee: Burford Corporation, Maysville, OK (US)

(21) Appl. No.: 15/726,485

(22) Filed: Oct. 6, 2017

Related U.S. Application Data
(60) Provisional application No. 62/404,824, filed on Oct. 6, 2016.

(51) Int. Cl. A21C 15/00; B65D 83/06

(52) U.S. Cl. CPC A21C 15/002; B65D 83/06

(57) ABSTRACT

A particulate dispenser configured to deposit particulate material onto food products includes a hopper and a brush assembly inside the hopper. The hopper has a front panel that has a lower extent and a hinge connected to the lower extent. The hopper also includes an access panel connected to the hinge on the lower extent of the front panel. The access panel is configured to be moved about the hinge between open and closed positions. The brush assembly is removable from the hopper when the access panel is in the open position.

### RELATED APPLICATIONS

This application claims the benefit of U.S. Provisional Patent Application No. 62/404,824, filed Oct. 6, 2016, entitled “Fine Particle Dispenser with Quick Access Panel,” the disclosure of which is herein incorporated by reference.

### FIELD OF THE INVENTION

The present invention generally relates to equipment used in the baking industry and more particularly, but not by way of limitation, to equipment configured to dispense flour or other fine particulate coatings onto bakery goods.

### BACKGROUND OF THE INVENTION

For many years, commercial bakeries have utilized assembly-line production to prepare and bake products. In many cases, baked goods are prepared by placing pans onto a conveyor system, loading dough into the pans and moving the pans and dough through preparation, cooking and packaging processes. Flour, spices and other particulate material is often dispensed onto the top of the dough as it passes through the bakery.

In the past, flour dispensers, or “dusters,” included a vertically-oriented bin that could be loaded with flour or other particulates from the top. Motorized paddles and brushes agitated the particulate material within the bin. A template with holes positioned at the bottom of the bin would allow the particulate material to fall onto the dough or other bakery products passing beneath the dispenser.

In some situations, the particulate material would become “bridged” or clogged within the bin. To free the clogged material, the operator would be required to disassemble a large portion of the dispenser. Similarly, the operator would need to disassemble a significant portion of the dispenser to change the brushes within the dispenser. Because these brushes are often sized and configured for a specific type of particulate material, the operator might have to disassemble the dispenser between runs of different bakery products. There is, therefore, a need for an improved bakery particulate dispenser that overcomes the deficiencies of the prior art.

### SUMMARY OF THE INVENTION

In some embodiments, the invention includes a particulate dispenser configured to deposit particulate material onto food products. The particulate dispenser includes a hopper and a brush assembly inside the hopper. The hopper has a front panel that has a lower extent and a hinge connected to the lower extent. The hopper also includes an access panel connected to the hinge on the lower extent of the front panel. The access panel is configured to be moved about the hinge between open and closed positions. The brush assembly is removable from the hopper when the access panel is in the open position.

In another aspect, the embodiments of the invention include a particulate dispenser configured to deposit particulate material onto food products. The particulate dispenser includes a hopper that has a shaft aperture and a brush assembly inside the hopper. The brush assembly has a brush shaft, a fixed bearing that supports an end of the brush shaft on the exterior the hopper, and a floating bearing that supports the brush shaft on the interior of the hopper. The floating bearing permits an angular articulate of the brush shaft about the shaft aperture.

In yet another aspect, embodiments of the invention include particulate dispenser that has a hopper and a brush assembly inside the hopper. The hopper includes a front panel and an access panel connected to the front panel. The brush assembly includes a brush shaft having a first end and a second end and one or more brushes connected to the brush shaft. The particulate dispenser includes a drive assembly configured to rotate the brush assembly and means for selectively securing the first end of the brush shaft to the drive assembly.

### BRIEF DESCRIPTION OF THE DRAWINGS

FIG. 1 is a perspective view of a particulate dispenser constructed in accordance with a presently preferred embodiment.

FIG. 2 is left side view of the particulate dispenser of FIG. 1.

FIG. 3 is a right side view of the particulate dispenser of FIG. 1.

FIG. 4 is a front view of the particulate dispenser of FIG. 1.

FIG. 5 is a front perspective view of the particulate dispenser of FIG. 1 with the access panel opened.

FIG. 6 is a front view of the particulate dispenser of FIG. 1 with the front cover and access panel removed.

FIG. 7 is a top view of the particulate dispenser of FIG. 1.

FIG. 8 is a bottom view of the particulate dispenser of FIG. 1.

FIG. 9 is a perspective view of the agitator paddle assembly.

FIG. 10 is a perspective view of the brush assembly.

FIG. 11 is a perspective view of the deposition template.

FIG. 12 is a left side view of the particulate dispenser with the drive assembly cover removed.

FIG. 13 is a close-up view of the quick-release connection of the brush assembly.

FIG. 14 is a close-up view of the quick-release connection of the brush assembly and intermediate shaft.

FIG. 15 is a close-up view of the floating bearing of the brush assembly.

### WRITTEN DESCRIPTION

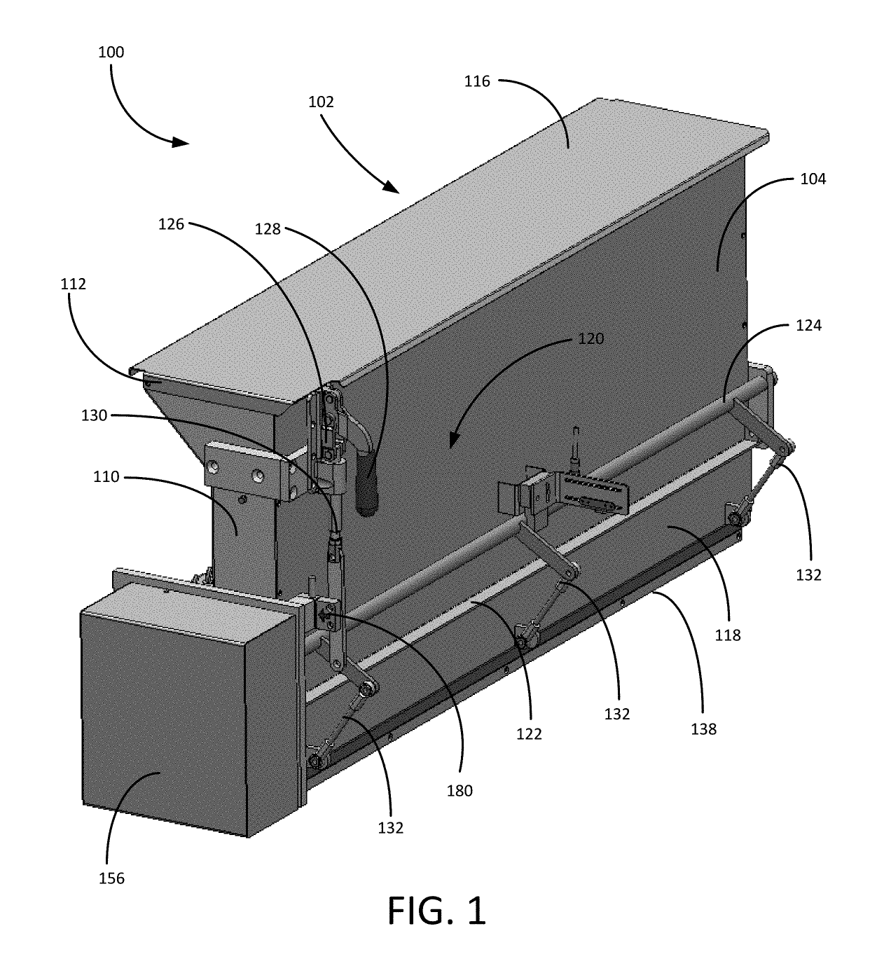

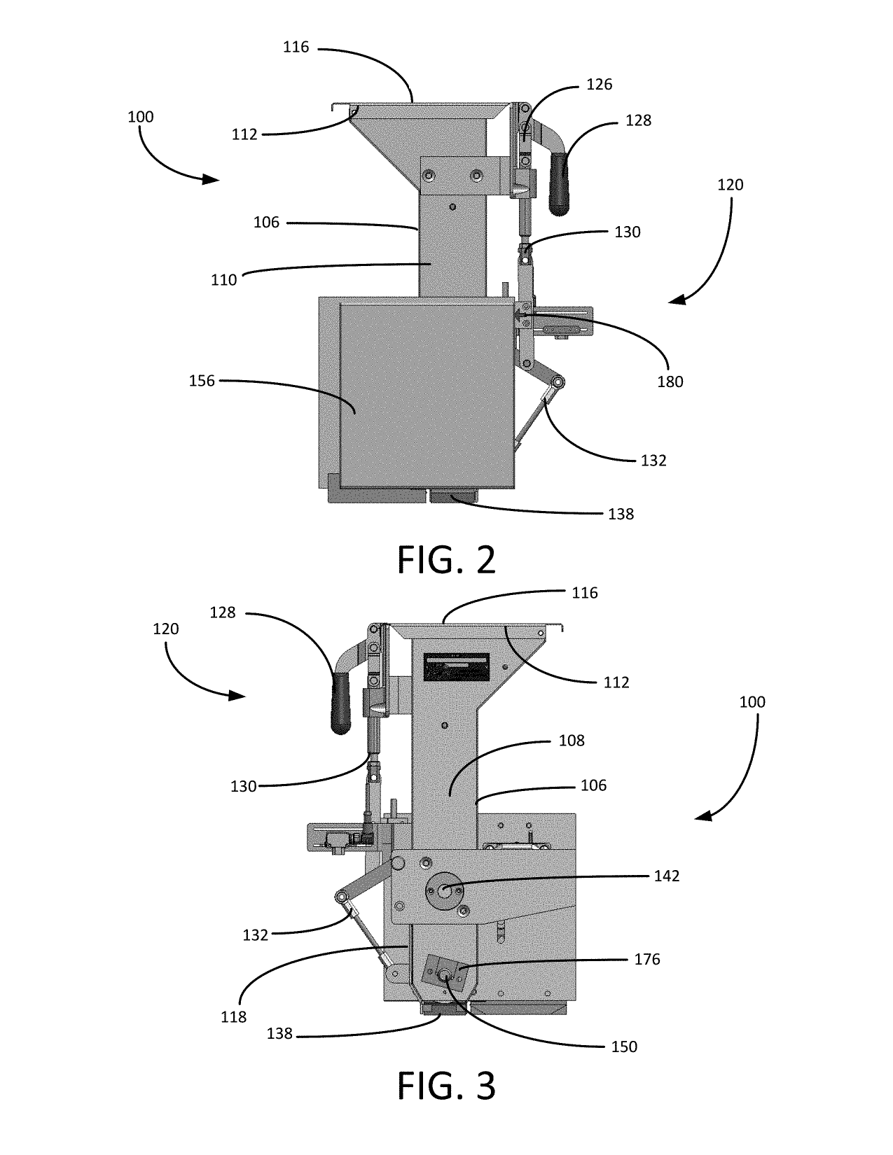

Referring first to FIGS. 1-4, shown therein are various views of a fine particulate dispenser 100. The particulate dispenser 100 is generally is well-suited for use in a commercial bakery, food processing facility or other location that employs automated assembly-line production processes. The particulate dispenser 100 is generally configured to deposit fine particulate material on a series of pans that are passed beneath the particulate dispenser 100 on an assembly line (not shown). The particulate dispenser 100 can be configured to deposit a wide variety of particulate material including flour, sugar, cinnamon and other toppings, ingredients and coatings found in bakery products.

The particulate dispenser 100 includes a hopper 102 that has a front panel 104, back panel 106, right side panel 108, left side panel 110, top opening 112 and bottom opening 114. The hopper 102 may include a lid 116 that covers the top opening 112. The lid 116 may include an opening (not shown) through which particulate material enters the hopper 102, or is configured to be opened and closed to provide access to the interior of the hopper 102. In particularly preferred embodiments, the hopper 102 is fed particulate material by an automatic delivery system. Suitable delivery systems include vacuum-powered and auger-driven mechanisms.

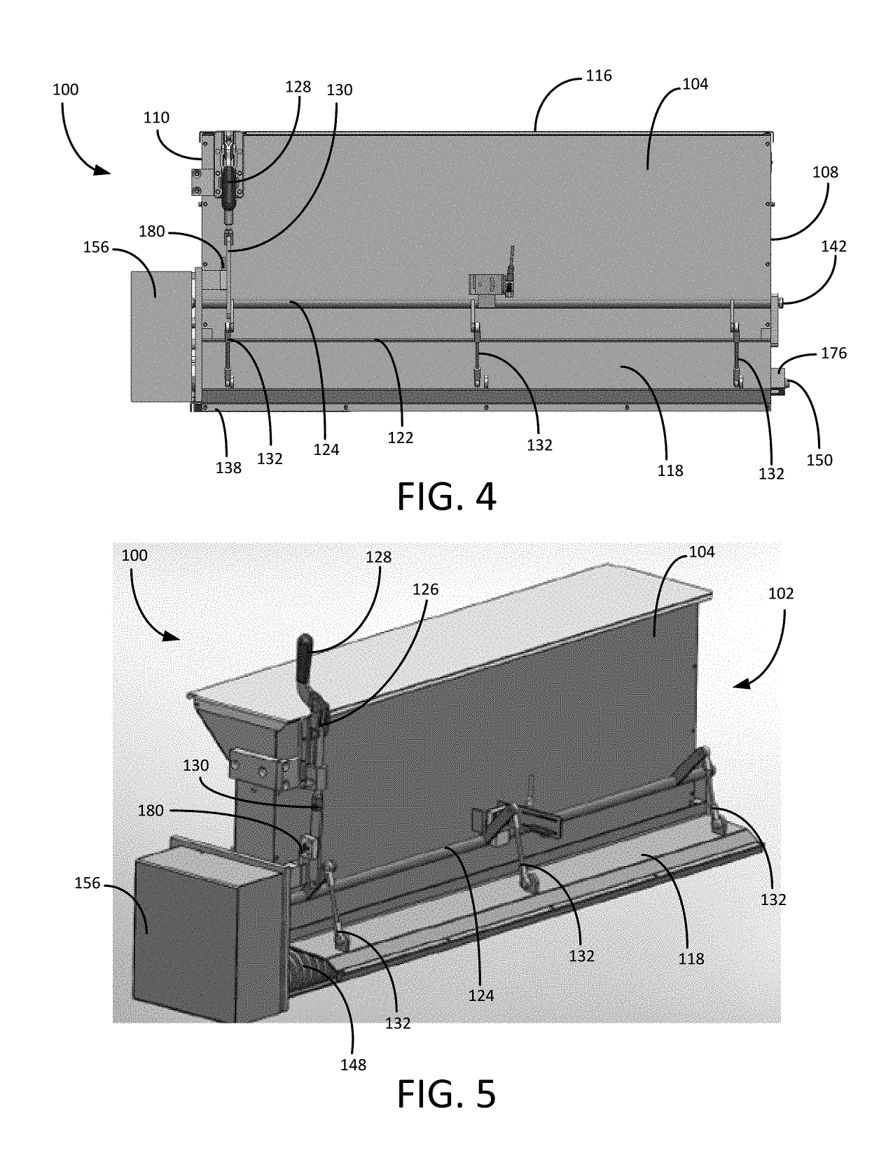

As best illustrated in FIGS. 1 and 4, the hopper 102 also includes an access panel 118 and lift mechanism 120. The access panel 118 is connected to the bottom of the front panel 104 with a hinge 122. The lift mechanism 120 includes a torsion bar 124, a latch 126, handle 128, an upper linkage 130 and one or more lower linkages 132. When the latch 126 is released and the handle 128 is raised, the upper linkage 130 lifts one of the lower linkages 132, which rotates the torsion bar 124 and thereby lifts the remaining lower linkages 132. As the lower linkages 132 are lifted, the bottom portion of the access panel 118 is raised to reveal the internal components within the hopper 102, as illustrated in FIG. 5. A position sensor 180 prevents the operation of the particulate dispenser 100 when the access panel 118 is in a raised position.

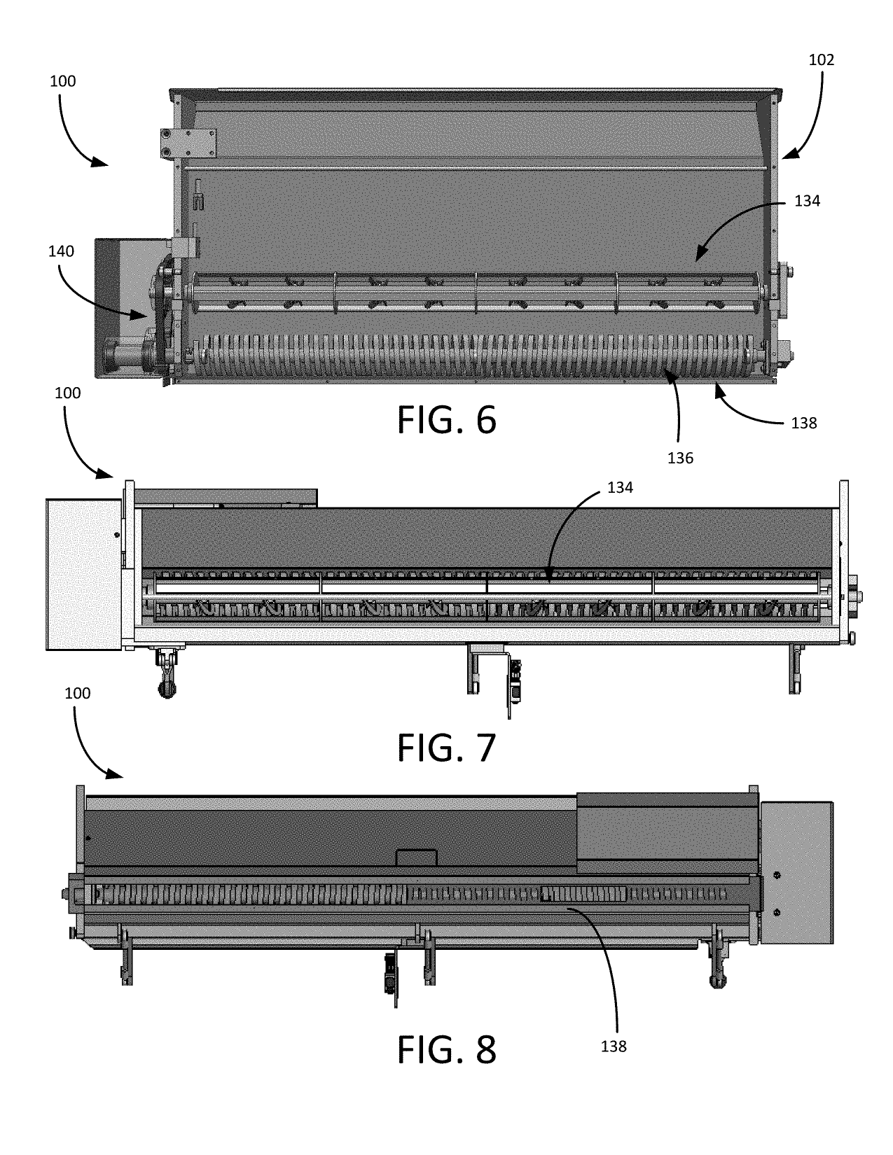

Turning to FIG. 6, shown therein is a front view of the particulate dispenser 100 with the front panel 104 and access panel 118 removed to reveal the internal components in the hopper 102. FIG. 7 provides a top view of the particulate dispenser 100 with the lid 116 removed. FIG. 8 provides a bottom view of the particulate dispenser 100. As shown in FIGS. 6-8, the particulate dispenser 100 includes an agitator paddle assembly 134, a brush assembly 136, a deposition template 138 and a drive assembly 140. The agitator assembly 134 is generally configured to provide mixing and distribution of the particulate material within the hopper 102. The brush assembly 136 is configured to push particulate material out of the hopper 102 through the deposition template 138.

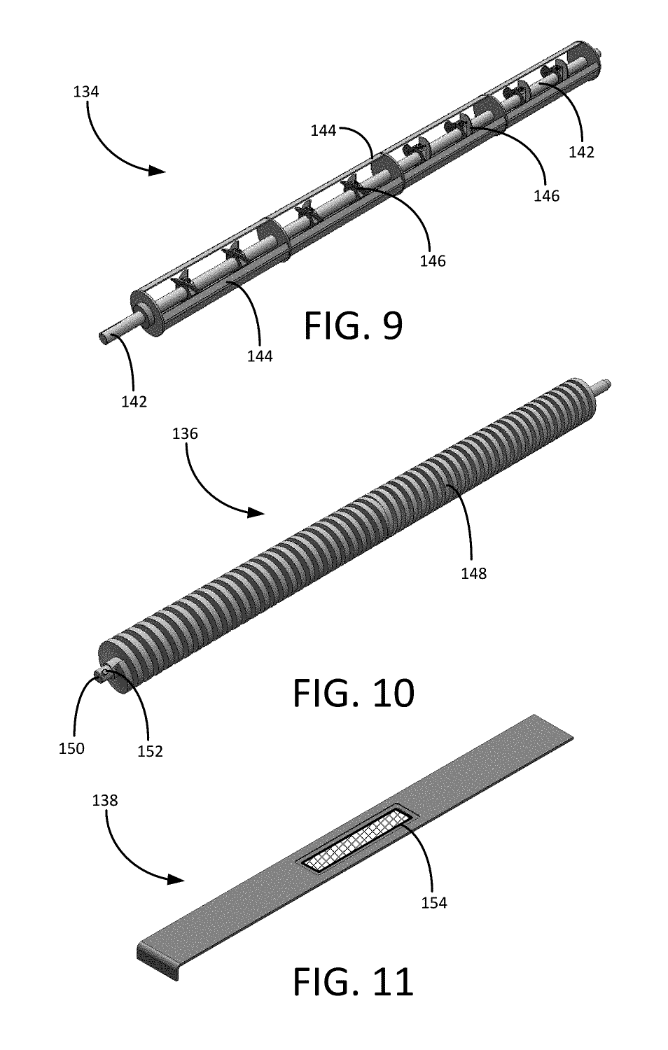

The agitator assembly 134 is depicted in isolation in FIG. 9. The agitator assembly 134 includes an agitator shaft 142, bar paddles 144 and flights 146. The bar paddles 144 and flights 146 are attached to the agitator shaft 142. When rotated, the bar paddles 144 mix the particulate material in the hopper 102. The flights 146 are preferably configured to push the particulate material away from the center of the hopper 102 to promote an even distribution of material within the hopper 102.

The brush assembly 136 is depicted in isolation in FIG. 10. The brush assembly includes a series of brushes 148 that are secured to a brush shaft 150 having a first end and a second end. In a particularly preferred embodiment, the brushes 148 are configured as one or more spiraled continuous brushes that are in contact with the interior side of the deposition template 138. When rotated, the brushes 148 encourage a lateral movement of the particulate material across the interior surface of the deposition template 138. In some embodiments, the brushes 148 include a pair of spiraled brushes that are oriented in opposite directions that spread the particulate material away from the center of the hopper 102. The first end of the brush shaft 150 includes a drive key 152.

Turning to FIG. 11, shown therein is an isolated perspective view of the deposition template 138. The deposition template 138 is configured to be removably connected to the bottom opening 114 of the hopper 102. The deposition template 138 includes one or more deposition holes 154 that permit particulate matter to fall out of the hopper 102. The deposition holes 154 may include a template screen having a desired mesh size to ensure that only the appropriately size and quantity of particulate material leaves the hopper 102.

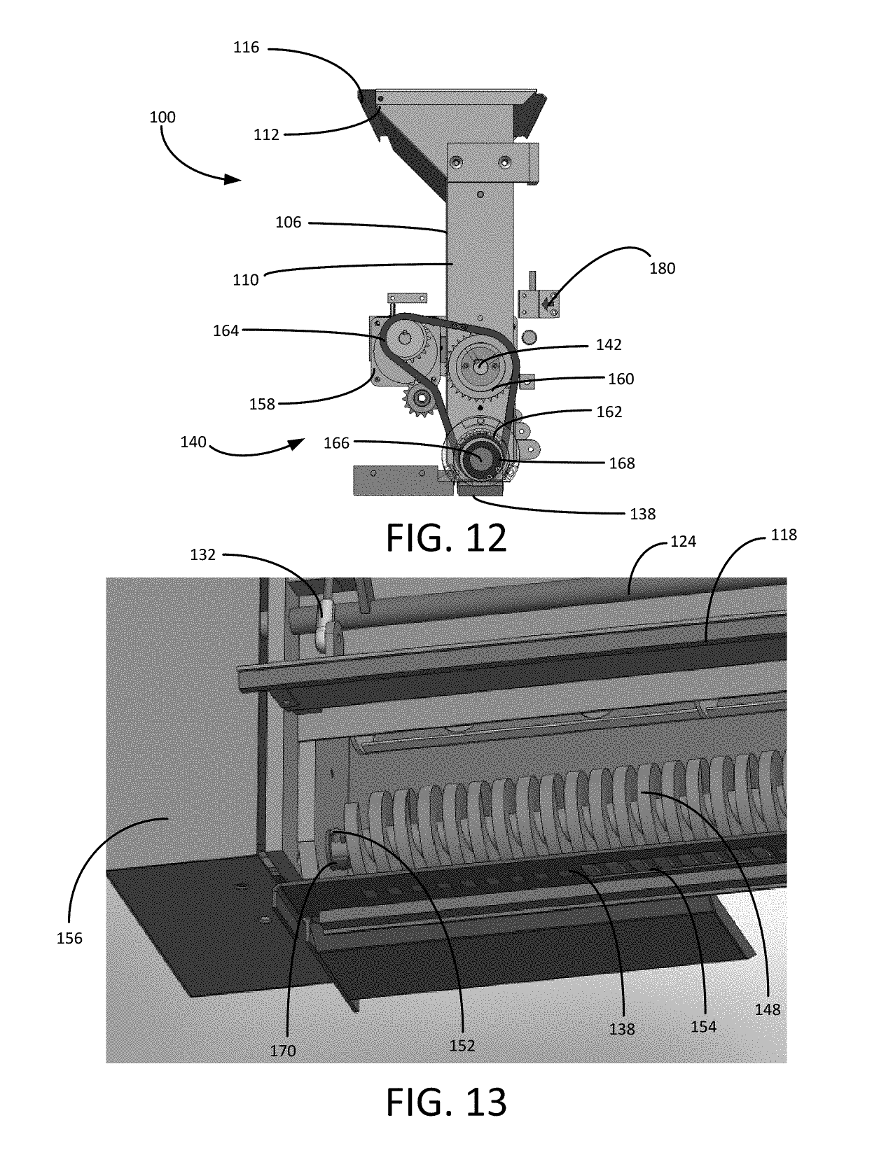

The drive assembly 140 is configured to rotate the agitator paddle assembly 134 and brush assembly 136. The drive assembly 140 includes a drive assembly cover 156, a motor 158, an agitator sprocket 160, a brush sprocket 162 and a drive chain 164. FIG. 12 provides a left side view of the particulate dispenser 100 with the drive assembly cover 156 removed to illustrate the components within the drive assembly 140. When selectively energized, the motor 158 turns the drive chain 164, which in turn rotates the agitator sprocket 160 and brush sprocket 162. In alternate embodiments, the drive chain 164 is replaced with a drive belt or with a series of directly connected gears.

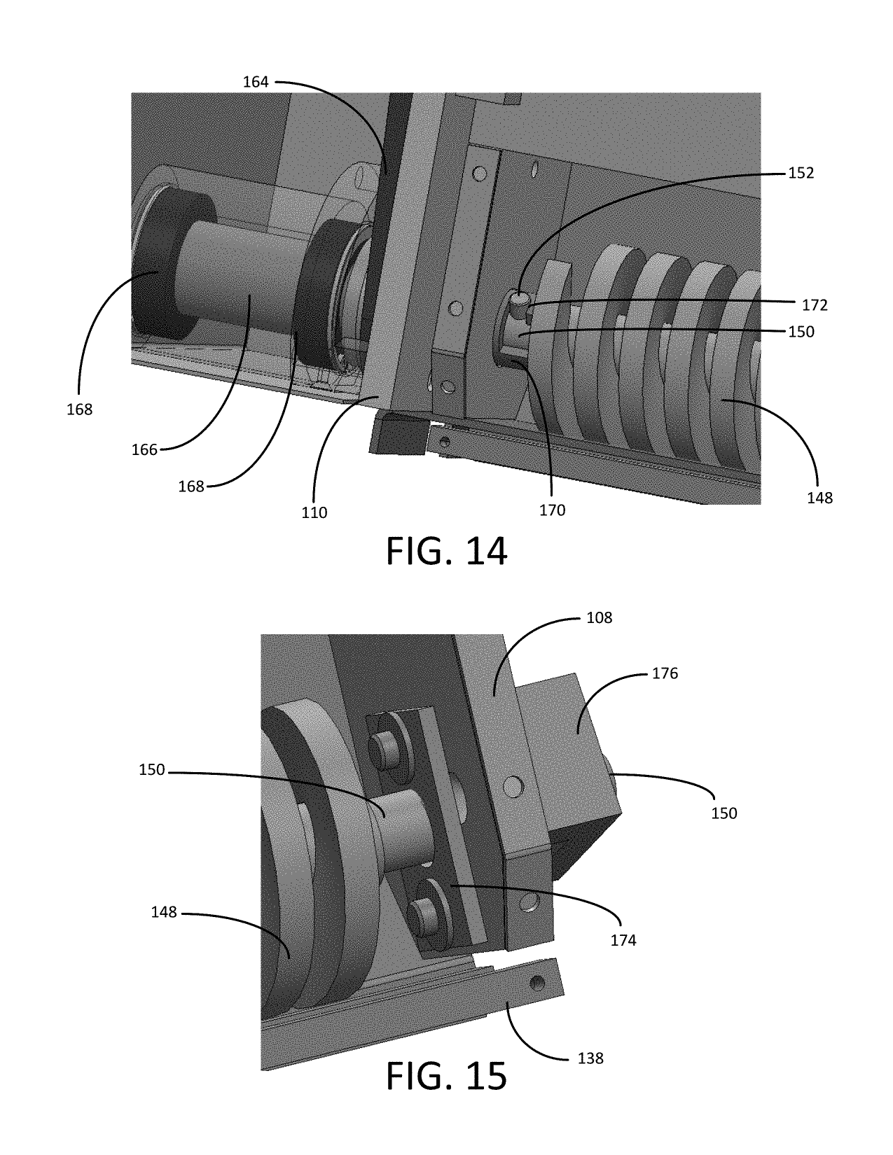

The agitator sprocket 160 is connected to the agitator shaft 142 with a press-fit or keyed connection. The brush sprocket 162 is connected to an intermediate shaft 166 that is supported by a brush bearing 168 within the drive assembly cover 156. The intermediate shaft 166 extends from the brush bearing 168 through the left side panel 110 and into the interior of the hopper 102. The intermediate shaft 166 includes a collar 170 that has a slot 172. The collar 170 is sized to accept the first end of the brush shaft 150. The slot is configured and sized to accept the drive key 152. As more clearly seen in FIGS. 13 and 14, the collar 170, slot 172 and drive key 152 cooperate to couple the intermediate shaft 166 to the brush shaft 150. During operation, the counterclockwise rotation of the intermediate shaft 166 and the resistance supplied by the particulate material to the brushes 148 prevent the drive key 152 from being removed from the slot 172.

However, the brush assembly 136 can be easily and quickly removed from the particulate dispenser 100 by manually rotating the brush assembly 136 to free the drive key 152 from the slot 172 when the access panel 118 is open and the motor 158 is not turning. Once the drive key 152 is freed from the slot 172, the first end of the brush assembly 136 can be pulled out of the hopper 102.

To permit the facilitated removal of the brush assembly 136 from the hopper 102, the brush assembly 136 includes a combination of a floating bearing 174 and fixed bearing 176 on the second, opposite end of the brush shaft 150, as illustrated in FIG. 15. The second end of the brush shaft 150 exits the hopper 102 through a shaft aperture 178 in the right side panel 108 that is larger than the outer diameter of the brush shaft 150. The floating bearing 174 is secured to the interior of the right side panel 108, but configured to permit an angular displacement of the brush shaft 150. Although the floating bearing 174 permits an angular articulation of the brush shaft 150, the floating bearing 174 prevents particular matter from exiting the hopper 102 through the shaft aperture 178. The fixed bearing 176 is attached to the exterior of the right side panel 108 and supports a portion of the weight of the brush assembly 136.

Thus, as described herein, the particulate dispenser 100 overcomes a number of deficiencies in the prior art. In particular, the access panel 118 provides facilitated access to the interior components of the hopper 102. This permits the operator to more quickly and easily manually exchange brush assemblies without the need for tools. Additionally, the access panel 118 permits the operator to more easily clean out particulate material from the hopper 102 in the event the material becomes clogged or if the particulate dispenser 100 will be used for a new operation and leftover particulate material needs to be removed from the hopper 102. The access panel 118 and brush removal mechanisms greatly facilitate the sanitation of the particulate dispenser 100.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms expressed herein and in the appended claims. It will be appreciated by those skilled in the art that the teachings of the present invention can be applied to other systems without departing from the scope and spirit of the present invention.

What is claimed is:

1. A particulate dispenser configured to deposit particulate material onto food products, the particulate dispenser comprising:
a hopper, wherein the hopper comprises:
a front panel, wherein the front panel has a lower extent and a hinge connected to the lower extent; and
an access panel connected to the hinge on the lower extent of the front panel, wherein the access panel is configured to be moved about the hinge between open and closed positions; and
a brush assembly inside the hopper, wherein the brush assembly is removable from the hopper when the access panel is in the open position.

2. The particulate dispenser of claim 1, further comprising a drive assembly configured to rotate the brush assembly in a first direction.

3. The particulate dispenser of claim 2, wherein the drive assembly comprises:
a motor;
a brush sprocket rotated by the motor;
an intermediate shaft connected to the brush sprocket; and
a collar connected to the intermediate shaft, wherein the collar has a slot.

4. The particulate dispenser of claim 3, wherein the brush assembly comprises:
a brush shaft;
one or more brushes connected to the brush shaft; and
a drive key connected to the brush shaft, wherein the drive key is configured to engage within the slot of the collar of the intermediate shaft.

5. The particulate dispenser of claim 4, wherein the one or more brushes comprise a spiraled continuous brush that extends along a middle portion of the brush shaft.

6. The particulate dispenser of claim 5, wherein the one or more brushes comprise a pair of spiraled brushes, wherein a first of the pair of spiraled brushes is oriented in a clockwise direction and a second of the pair of spiraled brushes is oriented in a counterclockwise direction.

7. The particulate dispenser of claim 6, wherein the particulate dispenser further comprises an agitator assembly and wherein drive assembly further comprises an agitator sprocket.

8. The particulate dispenser of claim 7, wherein the agitator assembly comprises:
an agitator shaft connected to the agitator sprocket;
a plurality of bar paddles connected to the agitator shaft; and
a plurality of flights connected to the agitator shaft.

9. The particulate dispenser of claim 8, wherein the drive assembly comprises a drive chain that connects the motor to the brush sprocket and agitator sprocket.

10. The particulate dispenser of claim 9, further comprising a deposition template adjacent the brush assembly, wherein the deposition template includes one or more deposition holes configured to permit particulate material to fall out of the hopper.

11. The particulate dispenser of claim 10, wherein the hopper further comprises a shaft aperture, wherein the brush shaft extends from an interior of the hopper to an exterior of the hopper through the shaft aperture, and wherein the brush assembly further comprises:
a fixed bearing that supports an end of the brush shaft on the exterior the hopper; and
a floating bearing that supports the brush shaft on the interior of the hopper and wherein the floating bearing permits an angular articulate of the brush shaft about the shaft aperture.

12. A particulate dispenser configured to deposit particulate material onto food products, the particulate dispenser comprising:
a hopper, wherein the hopper comprises a shaft aperture; and
a brush assembly inside the hopper, wherein the brush assembly comprises:
a brush shaft;
a fixed bearing that supports an end of the brush shaft on the exterior the hopper; and
a floating bearing that supports the brush shaft on the interior of the hopper and wherein the floating bearing permits an angular articulate of the brush shaft about the shaft aperture.

13. The particulate dispenser of claim 12, wherein the hopper comprises:
a front panel, wherein the front panel has a lower extent and a hinge connected to the lower extent; and
an access panel connected to the hinge on the lower extent of the front panel, wherein the access panel is configured to be moved about the hinge from a closed position to an open position to reveal the brush assembly.

14. The particulate dispenser of claim 13, further comprising a drive assembly configured to rotate the brush assembly in a first direction.

15. The particulate dispenser of claim 14, wherein the drive assembly comprises:
a motor;
a brush sprocket rotated by the motor;
an intermediate shaft connected to the brush sprocket and the brush shaft; and
a collar connected to the intermediate shaft, wherein the collar has a slot.

16. The particulate dispenser of claim 15, wherein the brush assembly further comprises:
one or more brushes connected to the brush shaft; and
a drive key connected to the brush shaft, wherein the drive key is configured to engage within the slot of the collar of the intermediate shaft.

17. The particulate dispenser of claim 16 further comprising an agitator assembly driven by the drive assembly, wherein the agitator assembly comprises:
an agitator shaft;
a plurality of bar paddles connected to the agitator shaft; and
a plurality of flights connected to the agitator shaft.

18. A particulate dispenser comprising:
a hopper, wherein the hopper comprises a front panel and an access panel connected to the front panel;
a brush assembly, wherein the brush assembly comprises:
a brush shaft having a first end and a second end; and
one or more brushes connected to the brush shaft;
a drive assembly configured to rotate the brush assembly; and
means for selectively securing the first end of the brush shaft to the drive assembly.

19. The particulate dispenser of claim 18, wherein the hopper includes a shaft aperture and wherein the second end of the brush shaft extends through the shaft aperture, wherein the particulate dispenser further comprises means for supporting the second end of the brush shaft.
